(19) United States
(12) Patent Application Publication
(10) Pub. No.: US 2012/0327982 A1
(43) Pub. Date: Dec. 27, 2012

(54) METHOD AND APPARATUS FOR SIGNAL DETECTION IN MULTIPLE INPUT MULTIPLE OUTPUT

(75) Inventors: Yu Ro LEE, Daejeon (KR); Sok Kyu LEE, Daejeon (KR)

(73) Assignee: Etectronics and Telecommunications Research Institute, Daejeon (KR)

(21) Appl. No.: 13/531,428

(22) Filed: Jun. 22, 2012

(30) Foreign Application Priority Data
Jun. 24, 2011 (KR) 10-2011-0061660

(51) Int. Cl. H04L 27/28; H04B 1/38

(52) U.S. Cl. 375/219; 375/260

(57) ABSTRACT

Disclosed is a method for detecting a multiple input multiple output (MIMO) transmission signal. The method for detecting a signal in multiple input multiple output (MIMO) transmission includes: acquiring M receiving symbols through each of the M receive antennas; determining a plurality of M-th candidate symbols to be determined as recovery symbols of an M-th receiving symbol received through the M-th receiving antenna among the M receive antennas; grouping the plurality of candidate symbols into N groups; and determining a plurality of M−1-th candidate symbols to be determined as recovery symbols of an M−1-th receiving symbol received through an M−1-th receive antenna for each of the N groups.

### CROSS-REFERENCE TO RELATED APPLICATIONS

This application claims the benefit of priority of Korean Patent Application No. 10-2011-0061660 filed on Jun. 24, 2011, which is incorporated by reference in their entirety herein.

### BACKGROUND OF THE INVENTION

1. Field of the Invention

The present invention relates to wireless communication, and more particularly, to a method and an apparatus for detecting a signal in multiple input multiple output (MIMO) transmission.

2. Related Art

In a wireless communication system for detecting high-speed data of a broadband, a multiple input multiple output (MIMO) technology to which an orthogonal frequency division multiplexing (OFDM) is applied has been in the limelight as a method for increasing channel capacity without additionally allocating frequency resources. The MIMO transmission using multiple transmit antennas and multiple receive antennas needs a detection method capable of separating independent data streams simultaneously transmitted from multiple antennas at an MIMO-OFDM receiving end.

As a method for detecting a signal at the receiving end of the OFDM-MIMO system, various methods, such as a maximum likelihood (ML) estimation algorithm, an M-algorithm, and the like, have been proposed. However, the method for detecting a signal at the receiving end of the MIMO system using the ML estimation method and the M-algorithm according to the related art may have many calculations and complexity.

A need exists for a method for detecting a signal having relatively low complexity while having performance similar to the ML estimation method.

### SUMMARY OF THE INVENTION

The present invention has been made in an effort to provide a method for detecting a signal and an apparatus supporting the same in a multiple input multiple output scheme having relatively low complexity while having performance similar to a method for detecting a signal using a maximum likelihood (ML) estimation method.

According to an exemplary embodiment of the present invention, there is provided a method for detecting method for detecting a signal in multiple input multiple output (MIMO) transmission includes: acquiring M receiving symbols through each of the M receive antennas; determining a plurality of M-th candidate symbols to be determined as recovery symbols of an M-th receiving symbol received through the M-th receiving antenna among the M receive antennas; grouping the plurality of candidate symbols into N groups; and determining a plurality of M−1-th candidate symbols to be determined as recovery symbols of an M−1-th receiving symbol received through an M−1-th receive antenna for each of the N groups.

### BRIEF DESCRIPTION OF THE DRAWINGS

FIG. 1 is a transmitting block diagram of an IEEE 802.11n system that is one of MIMO OFDM systems.

FIG. 2 is an example of a block diagram of a receiver corresponding to the transmitting block diagram of FIG. 1.

FIG. 3 is a block diagram showing an MIMO detection scheme using a grouping scheme according to an exemplary embodiment of the present invention.

FIG. 4 is an example of grouping a distance determined by detecting a symbol according to an exemplary embodiment of the present invention.

FIG. 5 is a block diagram showing in detail the MIMO detection scheme of each symbol.

FIG. 6 is a diagram showing an exemplary embodiment of the present invention under specific conditions.

FIG. 7 is a diagram showing a result of comparing a packet error rate (PER) between the invention with an ML receiver when transmitting four data streams and received the transmitted four data streams to four receivers.

### DESCRIPTION OF EXEMPLARY EMBODIMENTS

Hereinafter, exemplary embodiments of the present invention will be described with reference to the accompanying drawings. A method for detecting a signal at a receiving end according to an exemplary embodiment of the present invention may be applied to various communication systems based on multiple input multiple output (MIMO). For convenience of explanation, as an example of the communication system based on the MIMO, Institute of Electrical and Electronics Engineers (IEEE) 802.11 wireless LAN system will be described; however, the present invention is not limited thereto and therefore, may be used for a method for detecting a signal at a receiving end in various communication systems based on the MIMO as described above.

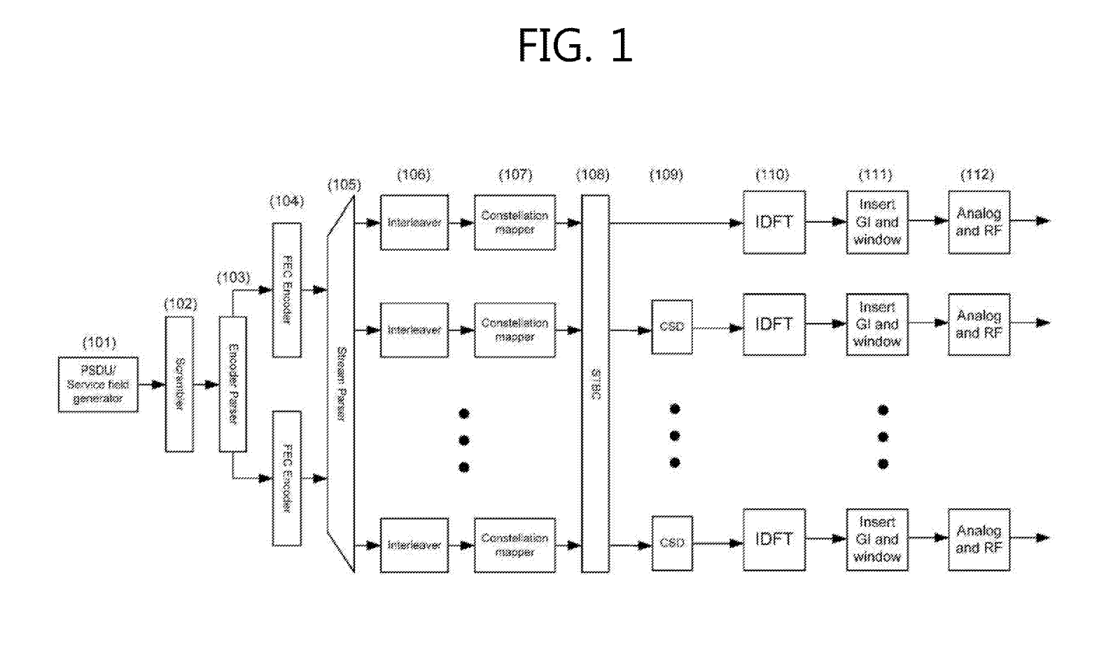

FIG. 1 is a transmitting block diagram of an IEEE 802.11n system that is one of MIMO OFDM systems.

In a physical layer (PHY layer) of the IEEE 802.11n system, a physical layer convergence procedure (PLCP) service data unit (PSDU) transferred from a medium access control (MAC) layer is transmitted through radio frequency (RF). An operation at the physical to layer will be briefly described with reference to FIG. 1.

In FIG. 1, a PSDU/Service field generator 101 generates the PSDU and a service field. A scrambler 102 scrambles the service field and the PSDU data. An encoder parser 103 parses and transmits data with each encoder when using at least one encoder. Thereafter, the data encoded with the encoder 104 is parsed into a plurality of transmitting streams in a stream parser 105, wherein the parsed stream is interleaved in an interleaver 106. The interleaved signal is mapped in a constellation mapper 107 by a modulation scheme such as BPSK, QPSK, 16QAM, and 64QAM. In some cases, the mapped signal is subjected to space-time block coding (STBC) (108), cyclic shift delay (CSD) for each stream (109), and inverse discrete Fourier transform (IDFT) (110). Thereafter, the mapped signal is subjected to windowing along with a guard interval (GI) (111), is D/A converted, and is then transmitted through RF (112).

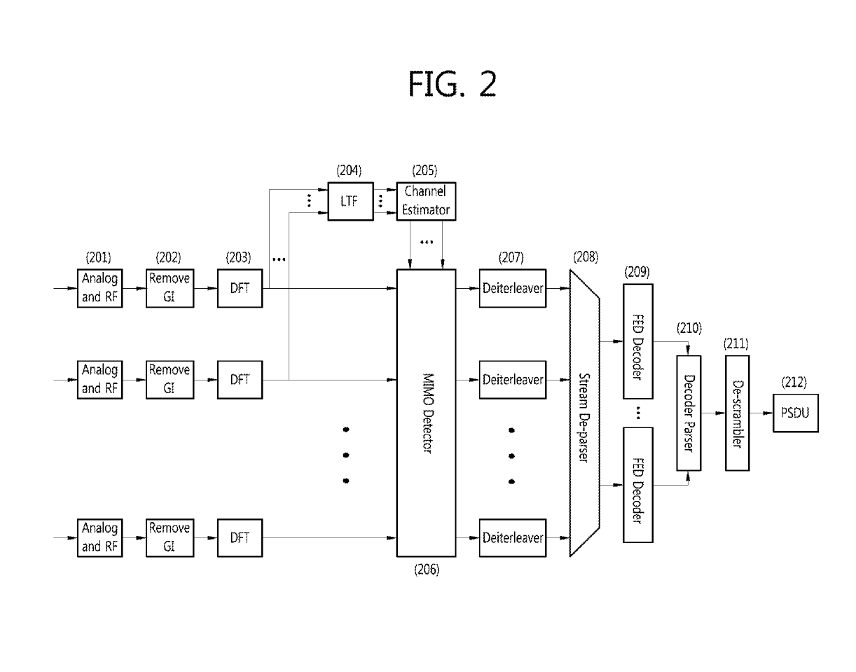

FIG. 2 is an example of a block diagram of a receiver corresponding to the transmitting block diagram of FIG. 1.

A signal received through a channel is transmitted through RF and is then subjected to the A/D conversion (201). The signal from which the GI is removed (202) is subjected to discrete Fourier transform (DFT) (203). In a PLCP protocol data unit (PPDU) format, channel estimation is performed (205) using a long training field (LTF) (204) and MIMO detection is performed using the received signal and the estimated channel signal (206). An output of the MIMO detection is deinterleaved (207) and is decoded (209) by passing through a steam de-parser (208). The decoded signal is descrambled (211) by passing through a decoder de-parser (210) and then, estimates the transmitted PSDU (212).

A received signal of a specific sub-carrier of a specific symbol in the received signal of FIG. 2 may be represented by the following Equation 1.

r=Hs+ñ=QRs+ñ [Equation 1]

Here, H represents an N×M channel matrix, s=[s₁, s₂, . . . , s_{M}]^{T} represents a transmit symbol vector, and ñ[ñ₁, ñ₂, . . . , ñ_{N}]^{T} represents a noise vector. Equations 2 and 3 may be obtained by performing QR decomposition on the channel matrix H and multiplying Q^{H} by both sides of Equation 1.

y=Q^{H}r=Q^{H}Hs+Q^{H}ñ=Q^{H}QRs+Q^{H}ñ=Rs+n [Equation 2]

$$[ \begin{matrix}{y}_{1} \\ {y}_{2} \\ ⋮ \\ {y}_{N}\end{matrix} ] = [ \begin{matrix}{r}_{1 , 1} & {r}_{1 , 2} & ⋯ & {r}_{1 , M} \\ 0 & {r}_{2 , 2} & … & {r}_{2 , M} \\ 0 & 0 & … & ⋮ \\ 0 & 0 & 0 & {r}_{N , M}\end{matrix} ] [ \begin{matrix}{s}_{1} \\ {s}_{2} \\ ⋮ \\ {s}_{M}\end{matrix} ] + [ \begin{matrix}{n}_{1} \\ {n}_{2} \\ ⋮ \\ {n}_{N}\end{matrix} ] \qquad [ Equation 3 ]$$

Considering the case in which the number M of transmit antennas is larger than the number N of receive antennas, Equation 3 may be represented by Equation 4.

$$[ \begin{matrix}{y}_{1} \\ {y}_{2} \\ ⋮ \\ {y}_{M}\end{matrix} ] = [ \begin{matrix}{r}_{1 , 1} & {r}_{1 , 2} & ⋯ & {r}_{1 , M} \\ 0 & {r}_{2 , 2} & … & {r}_{2 , M} \\ 0 & 0 & … & ⋮ \\ 0 & 0 & 0 & {r}_{M , M}\end{matrix} ] [ \begin{matrix}{s}_{1} \\ {s}_{2} \\ ⋮ \\ {s}_{M}\end{matrix} ] + [ \begin{matrix}{n}_{1} \\ {n}_{2} \\ ⋮ \\ {n}_{M}\end{matrix} ] \qquad [ Equation 4 ]$$

In FIG. 2, an example of an MIMO detector 206 may include a decision feedback equalizer (DFE), zero forcing (ZF), minimum mean square error estimation (MMSE), bell labs layered space-time (BLAST), and the like, which are less complex than maximum likelihood detection (MLD) but has lower performance than that of the MLD.

The ML detection for detecting a transmitted signal is based on selecting at least one candidate transmit symbol which has a minimum distance to received signal as following

ŝ_{ML}=arg minₛ_{^{c}}_{Es}E{∥y−Hs^{c}∥²} [Equation 5]

Here, s is signal constellation and c=1, 2, . . . , 2^{B} (B=2(QPSK), 4(16QAM), 6(64QAM)).

The ML receiving scheme finds a combination of symbols having the shortest distance among all of the possible symbol combinations and thus, the complexity thereof is very large.

For example, when the modulation scheme is 64QAM, it needs to find the shortest distance among combinations of distances corresponding to the number of possible cases 64×M. A process of obtaining 16,777,216 distances is required when M=4. Among these distances, it needs to find distances having a minimum value.

The general M-algorithm known as having even lower complexity than that of the ML obtains distances from each of the possible symbol candidate groups and then, compares the obtained distances to leave the distances corresponding to the number of defined paths.

When the possible constellation as the k-th symbol is sₖ={sₖ¹, . . . , sₖ^{C}}, the possible distance at the possible constellation as an M-th symbol may be represented by the following Equation 6. Here, C=2^{B}, wherein B is the number of bits transmitted as one symbol (64QAM: B=6, 16QAM: B=4, QPSK: B=2).

d_{M}^{c}=|y_{M}−r_{M,M}s_{M}^{c}|² [Equation 6]

When the number of leaving paths at the M-th symbol is pm, paths are left in d_{M}^{c} in order that p_{M} distances are small.

The method calculate distances for each antenna as many as p_{M-i-1}×C numbers and has complexity in which paths corresponding to p_{M-i} leave. Here, i is the number of antennas for search. For example, when searching the fourth symbol, i=1 and when searching the third symbol, i=2.

The method is simpler calculation than the ML, but has large complexity. For example, 64 paths leave every time each antenna symbol is determined, 64×4 distances are calculated for each antenna symbol search when using a 64 QAM transmission scheme, and 64 distances having a small value among 4096 distances are left to perform a next antenna symbol search. The scheme needs a complex select process of calculating 4096 distances and leaving 64 having a short distance among 4096 distances so as to search next antennas.

In the M-algorithm, when data of four streams are transmitted as the 64 QAM signals and 64 paths are left for each step so as to determine symbols, there is a need for a very complex comparison process so as to perform a multiplying operation for obtaining distances for each step 4096 times and to select 64 distances having a short distance among 4096 distances.

The exemplary embodiment of the present invention can reduce the number of multiplying operations so as to calculate the distance and reduce complexity since it is enough to determine only the minimum value while making the input size of the comparator small. In order to reduce the number of multiplying operations and simplify the comparison process, a distance of p_{M-i-1} selected at the previous step is divided into g_{M-i} groups to perform a search, thereby reducing the complexity.

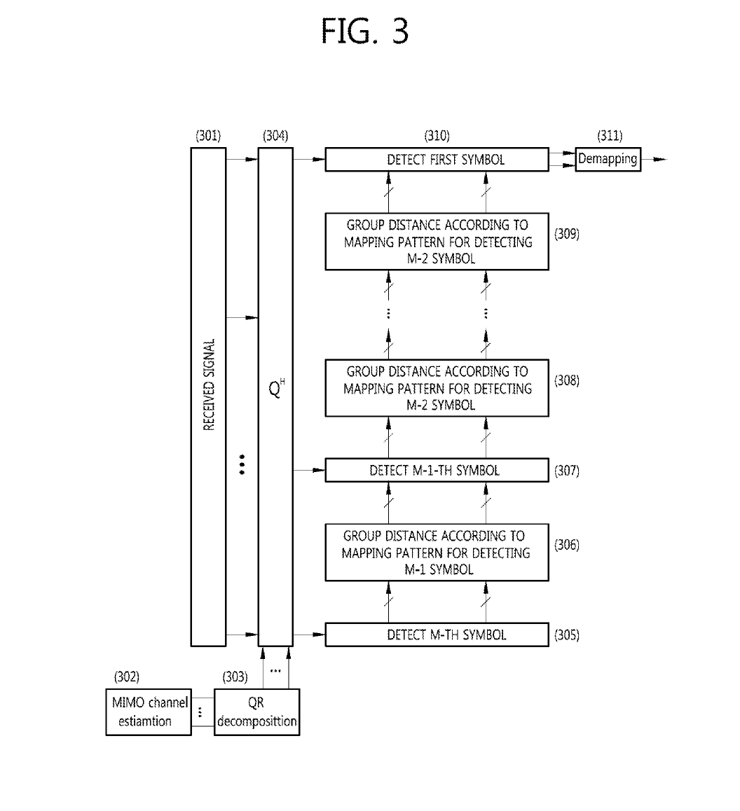

FIG. 3 is a block diagram showing an MIMO detection scheme using a grouping scheme according to an exemplary embodiment of the present invention.

A received signal 301 is a received signal after performing the DFT and a channel matrix 302 is a channel matrix performing the channel estimation by using the pilot signal (which may be variously referred to as a standard signal, a reference signal, and the like, according to a communication system), a long training field (LTF), or the like. The QR decomposition is performed by using the channel matrix 302 estimated as in Equation 1 (303). According to Equation 3, the channel matrix has an upper triangular matrix by multiplying Q^{H} by the received signal after performing the QR decomposition.

The MIMO detection may be performed by the following process.

(1) M-th Symbol Detection

In Equation 4, the M-th symbol may be obtained according to Equation 7.

y_{M}=r_{M,M}s_{M}+n_{M} [Equation 7]

Candidates that may be the M symbol may be applied in order that the distance is smallest at the time of calculating the distance of Equation 8.

D_{M}^{c}=|y_{M}−r_{M,M}s_{M}^{c}|² [Equation 8]

Here, D_{M}^{c} represents a distance, M represents a symbol to be currently determined, and c represents to which candidate symbols the corresponding symbols corresponds among the symbol candidates. According to the modulation scheme, the number of candidate symbols is two in the case of BPSK, the number of candidate symbols is four in the case of QPSK, the number of candidate symbols is 16 in the case of 16 QAM, and the number of candidate symbols is 64 in the case of 64 QAM. Therefore, a c value may have a value of 1 or 2 when being modulated into the BPSK and may have any one of 1 to 64 in the case of the signal modulated into the 64 QAM. When P1 numbers are left as possible candidate constellation points as the M-th symbol, they are left in order that the distance is small. In this case, the distance and the group of symbol candidates corresponding thereto may be represented by is Equation 9.

distance: {D_{M}¹,D_{M}², . . . ,D_{M}^{p}^{₁}} [Equation 9]

Group of symbol candidates corresponding to each distance: {s_{M}¹, s_{M}², . . . , s_{M}^{p}^{₁}}

In X_{b}^{a}, a is an index indicating to which distance the leaving distance corresponds, and b is a symbol index performing the current detection.

(2) Distance Grouping According to Distance Pattern for M−1 Symbol Detection

In order to lower the complexity of the comparator and the complexity of the distance calculation, the distance is mapped according to the number of defined groups. The distance mapped to a g-th group for detecting the M−1 symbol and the group of symbol candidates corresponding thereto may be represented by Equation 10.

Distance of g-th group: {D_{M}^{g}^{_{M-1}}^{,1},D_{M}^{g}^{_{M-1}}^{,2}, . . . ,D_{M}^{g}^{_{M-1}}^{,p}^{₂}^{/G}^{_{M-1}}} [Equation 10]

Group of symbol candidates corresponding to the distance of the g-th group: {s_{M}^{g}^{_{M-1}}^{,1}, s_{M}^{g}^{_{M-1}}^{,2}, . . . , s_{M}^{g}^{_{M-1}}^{,p}^{₁}^{/G}^{_{M-1}}}

Here, the G_{M-1}, means the number of groups for detecting the M−1 symbol.

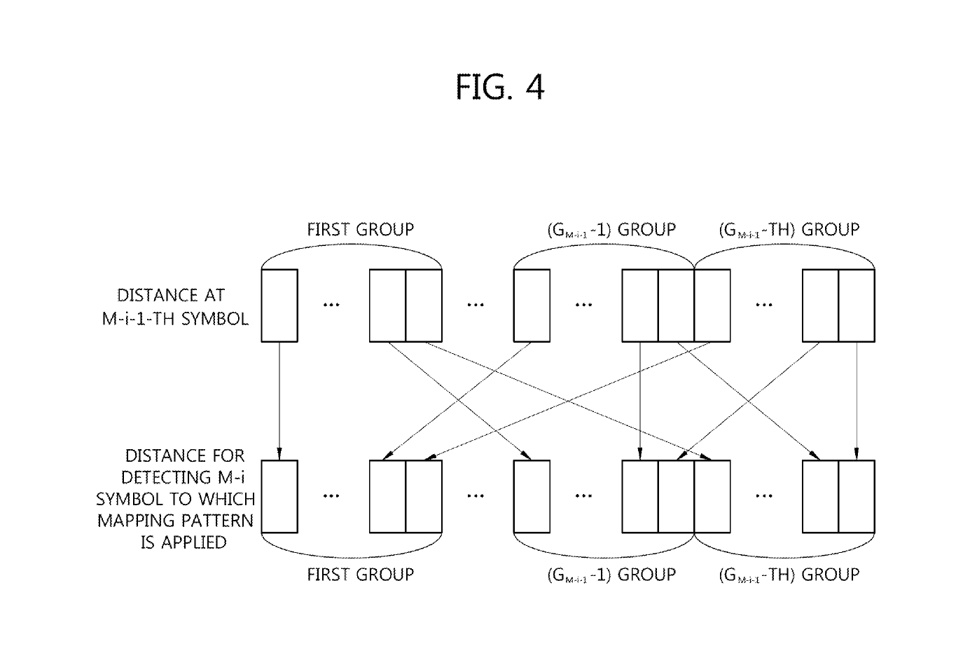

The mapping of distances to each group is randomly performed so that the distances having a small size are not mapped to the specific group. For example, this may be applied by to performing the mapping at a p₁/G_{M-1} interval, the mapping at a G_{M-1} interval, or generating a random pattern. FIG. 4 is an example in which the distance determined at M−i−1 symbol detection is mapped at the p₁/G_{M-1} interval to determine the M−i symbol.

(3) M−1 Symbol Detection

1) Priority of possible symbols as M−1 symbol is determined for the distance of each group.

For example, when the priority of the possible symbols as the M−1 symbol from a second symbol of the g-th group is defined, this may be represented by Equation 11.

y_{M-1}^{g}^{_{M-1}}^{,2}=y_{M-1}−r_{M-1,M}s_{M}^{g}^{_{M-1}}^{,2}+n_{M-1} [Equation 11]

In Equation 11, when the priority is defined from the nearest constellation, this becomes {s_{M-1}^{g}^{_{M-1}}^{,2,1}, s_{M-1}^{g}^{_{M-1}}^{,2,2}, . . . , s_{M-1}^{g}^{_{M-1}}^{,2,c}} in a symbol having high priority.

2) Determine a shortest distance for each group

3) Determine a distance for detecting the M−2 symbol while modifying an update distance for each group.

For example, when the second distance of the g-th group is set to be the shortest distance of the g-th group, the distance is updated from the symbol having the high priority corresponding to the second distance. The distance is accumulated with the distance of the M-th symbol and may be calculated according to Equation 12.

D_{M-1}^{g}^{_{M-1}}^{,2,1}=|y_{M-1}^{g}^{_{M-1}}^{,2}r_{M-1,M-1}s_{M-1}^{g}^{_{M-1}}^{,2,1}|²+D_{M}^{g}^{_{M-1}}^{,2} [Equation 12]

The update distance may be represented by Equation 13.

{D_{M}^{g}^{_{M-1}}^{,1},D_{M-1}^{g}^{_{M-1}}^{,2,1}, . . . ,D_{M}^{g}^{_{M-1}}^{,p}^{₁}^{/G}^{_{M-1}}} [Equation 13]

The distance for detecting the M−2 symbol and the group of symbol candidates corresponding thereto may be represented by Equation 14.

Distance of g-th group: {D_{M-1}^{g}^{_{M-1}}^{,2,1}} [Equation 14]

Group of symbol candidates corresponding to the distance of the g-th group: {{s_{M}^{g}^{_{M-1}}^{,2}, s_{M-1}^{g}^{_{M-1}}^{,2,1}}}

The minimum value of the update distance of Equation 13 is obtained. When the second distance is minimum, the distance of the second symbol is updated. The distance of the first symbol s_{M-1}^{g}^{_{M-1}}^{,1,1} having the high priority is calculated in advance and therefore, the distance having the high priority is calculated.

D_{M-1}^{g}^{_{M-1}}^{,2,2}=|y_{M-1}^{g}^{_{M-1}}^{,2}r_{M-1,M-1}s_{M-1}^{g}^{_{M-1}}^{,2,2}|²++D_{M}^{g}^{_{M-1}}^{,2} [Equation 15]

The update distance may be represented by Equation 16.

{D_{M}^{g}^{_{M-1}}^{,1},D_{M-1}^{g}^{_{M-1}}^{,2,2}, . . . ,D_{M}^{g}^{_{M-1}}^{,p}^{₁}^{/G}^{_{M-1}}} [Equation 16]

The distance for detecting the M−2-th symbol and the group of symbol candidates corresponding thereto may be represented by Equation 17.

Distance of g-th group: {D_{M-1}^{g}^{_{M-1}}^{,2,1},D_{M-1}^{g}^{_{M-1}}^{,2,2}} [Equation 17]

Group of symbol candidates corresponding to the distance of the g-th group: {{s_{M}^{g}^{_{M-1}}^{,2,}, s_{M-1}^{g}^{_{M-1}}^{,2,1}}{{s_{M}^{g}^{_{M-1}}^{,2}, s_{M-1}^{g}^{_{M-1}}^{,2,1}},

When the shortest distance of Equation 16 is obtained and the shortest distance is a 1st distance, the update distance and the number of distances for detecting the M−2 symbol may be represented by Equation 18.

D_{M-1}^{g}^{_{M-1}}^{,1,1}=|y_{M-1}^{g}^{_{M-1}}^{,1}−r_{M-1,M-1}s_{M-1}^{g}^{_{M-1}}^{,1,1}|²++D_{M}^{g}^{_{M-1}}^{,1} [Equation 18]

In this case, the update distance may be represented by Equation 19.

{D_{M-1}^{g}^{_{M-1}}^{,1,1},D_{M-1}^{g}^{_{M-1}}^{,2,2}, . . . ,D_{M}^{g}^{_{M-1}}^{,p}^{₁}^{/G}^{_{M-1}}} [Equation 19]

The distance for detecting the M−2 symbol and the group of symbol candidates corresponding thereto may be represented by Equation 20.

Distance of g-th group: {D_{M-1}^{g}^{_{M-1}}^{,2,1},D_{M-1}^{g}^{_{M-1}}^{,2,2},D_{M-1}^{g}^{_{M-1}}^{,1,1}} [Equation 20]

Group of symbol candidates corresponding to the distance of the g-th group: {{s_{M}^{g}^{_{M-1}}^{,2}, s_{M-1}^{g}^{_{M-1}}^{,2,1}}, {s_{M}^{g}^{_{M-1}}^{,2}, s_{M-1}^{g}^{_{M-1}}^{,2,2}}, {s_{M}^{g}^{_{M-1}}^{,1}, s_{M-1}^{g}^{_{M-1}}^{,1,1}}}

The above processes are repeatedly performed p₂/G_{M-1} times. In all the groups, when the above processes are performed, the generated distances and the symbol groups corresponding thereto can be obtained as p2 numbers.

Distance: {D_{M-1}¹,D_{M-1}², . . . ,D_{M-1}^{p}^{₁}} [Equation 21]

Group of symbol candidates corresponding to each distance: {{s_{M-1}^{1,M}, s_{M-1}^{1,M-1}}, . . . , {s_{M-1}^{p}^{_{z}}^{,M}, s_{M-1}^{p}^{_{z}}^{,M-1}}}

Here, in s_{c}^{a,b}, a is an index indicating to which distance the leaving distance corresponds, c is a symbol index performing the current detection, and b is estimation symbols of each antenna.

The processes (2) and (3) are repeated until the first symbol is detected (308 to 310). As a result, the distance and the group of symbol candidates corresponding thereto may be represented by Equation 21.

Distance: {D₁¹,D₁², . . . ,D₁^{p}^{_{M-1}}} [Equation 21]

Group of symbol candidates corresponding to each distance: {{s₁^{1,M}, s₁^{1,M-1}, . . . , s₁^{1,1}}, . . . , {s₁^{p}^{_{M-1}}^{,M}, s₁^{p}^{_{M-1}}^{,M-1}, . . . , s₁^{p}^{_{M-1}}^{,1}}}

Among those, the symbols from M-th to first corresponding to the distances having a minimum value may be determined.

The value input to the interleaver may be determined using a minimum value among the distances corresponding to the symbols including bits opposite to the symbols determined using a generally used method. When no symbols including opposite bits are, an average of the determined interleaver input values may be applied.

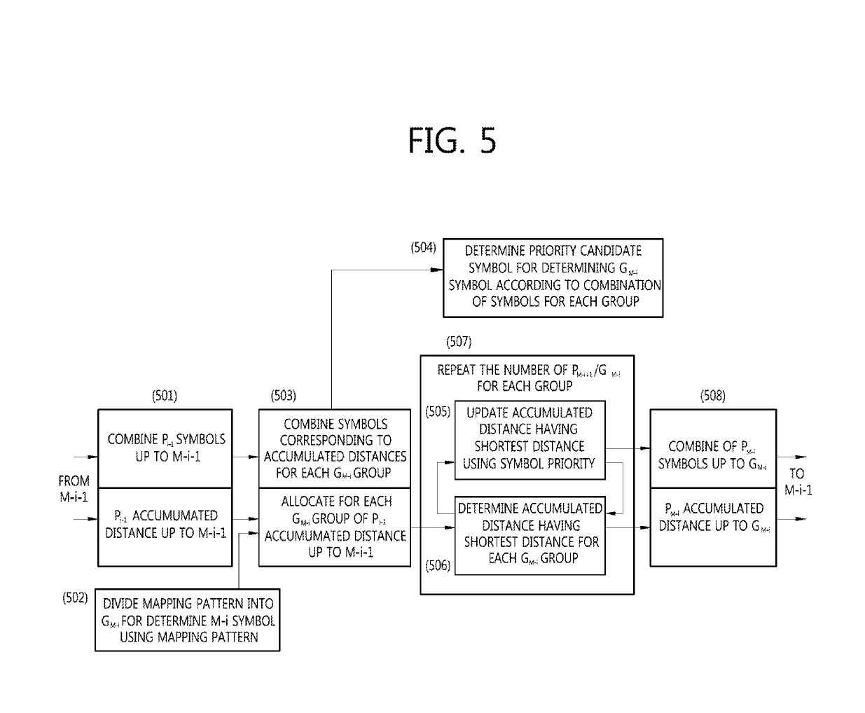

FIG. 5 is a block diagram showing in detail the MIMO detection method of each symbol.

Reference numeral 501 represents a distance from the M−i−1 symbol and a combination of the symbols for determining the M−i symbol, which are divided into G_{M-i} numbers by applying the specific mapping pattern 502. As such, the distance for each group and a combination of the symbols corresponding thereto are divided (503) and the priority of the candidate symbols for the distances within each group is determined (504). The accumulated distance having the shortest distances for each of the G_{M-i} groups is determined (506), which is determined as the distance for the M−i+1-th symbol (508). The accumulated distance having the shortest distance is updated using the priority of the symbols (505) and the combination up to the i-th symbol for detecting the M−i+1-th symbol is determined (508). The process is repeated up to P_{M-i+1}/G_{M-i} numbers for each group (507).

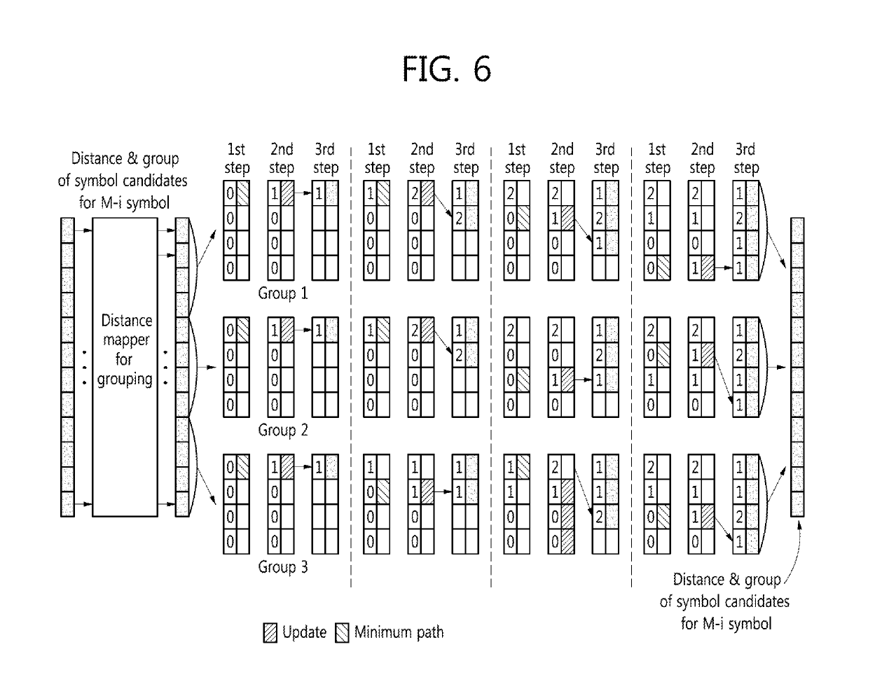

FIG. 6 shows a case of p_{M-i-1}=12, p_{M-i}=12, g_{M-i}=3 as the exemplary embodiment.

In order to determine the p_{M-i} distances and the M−i symbols, the following three steps, that is, the minimum search (1^{st} step), the update distance (2^{nd} step), and the determination of the distance and the group of symbol candidates for determining the M−i+1 symbols (3^{rd} step) are repeated.

Table 1 shows a result of comparing the complexity between the invention and the ML receiver and the receiver to which the general M-algorithm is applied. In the case of the multiplier, the numbers are very small and in the case of the comparator, the input numbers are very small for comparison as compared with the receiver to which the general M algorithm is applied and thus, the complexity is very low.

TABLE 1

| | | General M Algorithm | The Invention |
|---|---|---|---|
| | ML | {64, 64, 64, 64} | {64, {8, 16}, {8, 16}, {8, 16}} |
| Real mulitplier | 134,217,728 | 37,052 | 896 |
| for calculating | | | |
| distance | | | |
| Comparator | Comparator searching | Demand comparator Searching 64 | Second Symbol Detection: Demand 128 |
| | minimum value among | in small order among 4096 for | comparators searching minimum value |
| | 16,777,216 | each of the 2, 3, 4-th antenna | among 8 |
| | | (Very complex as compared with | Third and fourth symbols: Demand 128 |
| | | comparator searching minimum value) | comparators searching minimum value |
| | | | among 16 |

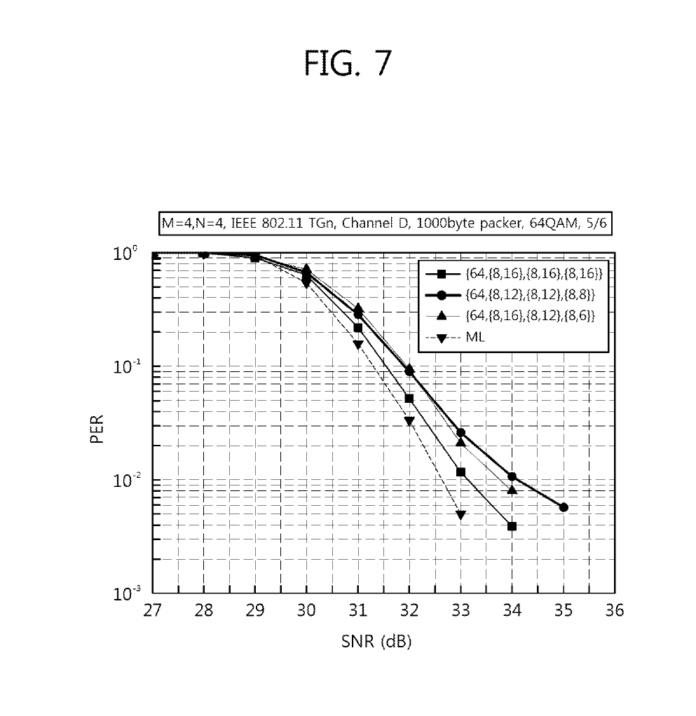

FIG. 7 is a diagram showing a result of comparing a packet error rate (PER) between the invention with an ML receiver when transmitting four data streams and received the transmitted four data streams to four receivers. In parameters {a1, {a2, a3}, {a4, a5}, {a6, a7}}, a1 represents the number of leaving distances for detecting the M symbol, a2 represents the number of groups for detecting the M−1 symbol, and a3 represents the number of searched distances for detecting the M−1 symbol, which are a value corresponding to reference numeral 507 of FIG. 5. a4 represents the number of groups for detecting the M−2 symbol, a5 represents the number of searched distances for detecting the M−2 symbol, which is a value corresponding to reference numeral 507 of FIG. 5, a6 is the number of groups for detecting the M−3 symbol and a7 is the number of searched distances for detecting the M−3 symbol, which are a value corresponding to reference numeral 507 of FIG. 5. In 1000 byte packets, IEEE802.11 TGn Ch. D, in the case of performing the processes of the grouping into {64, {8, 16}, {8, 16}, {8,16}} and the detection, the difference in PER with the ML receiver is about 0.5 dB, which may greatly reduce the complexity without increasing the difference in PER.

The wireless device that can implement the method for detecting an MIMO signal according to various exemplary embodiments of the present invention may include a processor, a memory, and a transceiver. The transceiver is set to transmit/receive a wireless frame through multiple antennas. The processor is functionally connected with the transceiver and is set to detect the MIMO signal according to the exemplary embodiments of the present invention. The wireless device may be operated as a station of the IEEE 802.11 according to the wireless communication protocol and setting implemented by the processor.

The processors and/or the transceiver may include an application-specific integrated circuit (ASIC), other chipsets, logical circuits, and/or data processing devices. The memory may include a read-only memory (ROM), a random access memory (RAM), a flash memory, a memory card, a storage medium, and/or other storage apparatus. When the embodiment is implemented by software, the above-mentioned method may be implemented by a module (process, function, or the like) that performs the above-mentioned function. The module is stored in the memory and may be executed by the processor. The memory may be located inside or outside the processor and may be connected with well known various devices.

The above-mentioned embodiments include examples of various aspects. Although all possible combinations showing various aspects are not described, it may be appreciated by those skilled in the art that other combinations may be made. Therefore, the present invention should be construed as including all other substitutions, alterations and modifications belong to the following claims.

The present invention provides a similar performance with the maximum ML estimation and reduce a complexity and a required time for determining a symbol in signal detection in MIMO transmission scheme.

What is claimed is:

1. A method for detecting a signal in multiple input multiple output (MIMO) transmission, comprising:
acquiring M receiving symbols through each of the M receive antennas;
determining a plurality of M-th candidate symbols to be determined as recovery symbols of an M-th receiving symbol received through the M-th receiving antenna among the M receive antennas;
grouping the plurality of candidate symbols into N groups; and
determining a plurality of M−1-th candidate symbols to be determined as recovery symbols of an M−1-th receiving symbol received through an M−1-th receive antenna for each of the N groups.

2. The method of claim 1, wherein the acquiring of the receiving symbols further includes:
estimating an MIMO channel through which the M receiving symbols are transmitted; and
multiplying QH obtained by QR-decomposing a channel matrix H of the estimated MIMO channel by the signals received through the M antennas.

3. The method of claim 1, wherein the determining of the M-th symbol candidate includes:
acquiring a plurality of distance data by calculating a distance between the M-th candidate symbol and each of the possible constellation points as the M-th symbol; and
determining a predetermined number of candidate symbols in an order of distance data having a small value among the plurality of distance data.

4. The method of claim 3, wherein each of the possible constellation points as the M-th symbol is determined by a modulation and coding scheme (MCS) value applied to the receiving symbols.

5. The method of claim 3, wherein the grouping step includes mapping the plurality of candidate symbols to the N groups, and a mapping pattern is applied to the mapping so that some symbols having a short distance to each of the possible constellation points as the M-th symbol among the plurality of candidate symbols are not concentratedly mapped to a specific group of the N groups.

6. The method of claim 1, wherein the M−1-th candidate symbol determining step includes:
determining priority of possible symbols as an M−1-th symbol for each distance between the candidate symbols mapped to each of the N groups and each of the possible constellation points as the M−1-th symbol; and
calculating a minimum distance between the candidate symbols and each of the possible constellation points as the M−1-th symbol in each of the N groups according to the priority.

7. A wireless device for detecting a signal in Multiple Input Multiple Output (MIMO) transmission, comprising:
a transceiver configured to receive the MIMO transmission signal through multiple antennas; and
a processor functionally connected with the transceiver,
wherein the processor is set to:
acquire M receiving symbols through each of the M receive antennas;
determine a plurality of candidate symbols to be determined as recovery symbols of an M-th receiving symbol received through the M-th receiving symbol among the M receive antenna;
group the plurality of candidate symbols into N groups; and
determine the plurality of candidate symbols to be determined as recovery symbols of an M−1-th receiving symbol received through an M−1-th receive antenna for each of the N groups.

8. The wireless device of claim 7, wherein the processor is set to:
estimate an MIMO channel through which the M receiving symbols are transmitted; and
acquire the receiving symbols by multiplying QH obtained by QR-decomposing a channel matrix H of the estimated MIMO channel by the signal received through the M antennas.

9. The wireless device of claim 7, wherein the determining of the M-th symbol candidate by the processor is performed by:
acquiring a plurality of distance data by calculating a distance between the M-th candidate symbol and each of the possible constellation points as the M-th symbol; and
determining a predetermined number of candidate symbols in an order of distance data having a small value among the plurality of distance data.

10. The wireless device of claim 9, wherein each of the possible constellation points as the M-th symbol is determined by a modulation and coding scheme (MCS) value applied to the receiving symbols.
